(19) United States
(12) Patent Application Publication
(10) Pub. No.: US 2019/0245236 A1
(43) Pub. Date: Aug. 8, 2019

(54) POLYMER ELECTROLYTE FUEL CELL STACK

(71) Applicant: Panasonic Intellectual Property Management Co., Ltd., Osaka (JP)

(72) Inventors: YOSHIFUMI TAGUCHI, Osaka (JP); KOZUE KUNIYOSHI, Osaka (JP); MIYUKI YOSHIMOTO, Osaka (JP)

(21) Appl. No.: 16/254,565

(22) Filed: Jan. 22, 2019

(30) Foreign Application Priority Data
Feb. 8, 2018 (JP) 2018-021070

(51) Int. Cl. H01M 8/2475; H01M 8/0247; H01M 8/248; H01M 8/0258; H01M 8/0267

(52) U.S. Cl. CPC H01M 8/2475; H01M 8/0247; H01M 2008/1095; H01M 8/0258; H01M 8/0267; H01M 8/248

(57) ABSTRACT

A fuel cell stack includes: a cell stack including separator plates, and cells each placed between the separator plates; a pair of current collectors that hold external lateral surface of the cell stack in a cell-stacking direction; and a pair of end plates that hold the pair of current collectors from outsides of said current collectors in the cell-stacking direction, wherein the cell stack possesses (i) at least one first opening formed on one external lateral surface of said cell stack, said one external lateral surface located along a direction perpendicular to the cell-stacking direction, (ii) a second opening formed on an external lateral surface of the cell stack opposite to the one external lateral surface, and (ii) at least one passage that extends through an inside of the cell stack from the at least one first opening or the at least one second opening.

### TECHNICAL FIELD

The technical field relates to polymer electrolyte fuel cell stacks.

### BACKGROUND

In the past, polymer electrolyte fuel cell stacks have been known.

Polymer electrolyte fuel cell stacks have structures in which fuel cell units (hereinafter, simply referred to as “cell(s)”) are stacked.

Cells each includes membrane electrode assemblies (MEAs) that includes polyelectrolyte membranes, and pairs of electrodes, between which the polyelectrolyte membranes are placed.

Then, the cells are stacked or adhered to one another through separator plates to thus form fuel cell stacks.

Polyelectrolyte membranes forming membrane electrode assemblies are formed of electrolytes having polymer ion-exchange membranes such as sulfonic group-possessing fluororesin-type ion-exchange membranes, and hydrocarbon resin-type ion-exchange membranes.

Moreover, for example, electrodes are located at sides of the polyelectrolyte membranes, and are formed of catalyst layers that promote redox reactions in catalyst electrodes, and gas diffusion layers that are located at outer sides of the catalyst layer and that have air permeability and electrical conductivity.

Furthermore, for example, catalyst layers in the fuel electrodes (anodes) include platinum, alloys of platinum and ruthenium, or the like, while catalyst layers in the air electrodes (cathodes) include platinum, alloys of platinum and cobalt, or the like.

Separator plates present inside cells are electrically-conductive members that prevent fuel gases supplied to the fuel electrodes from mixing with oxidant gases supplied to the air electrodes.

Additionally, sealing members for securing gas tightness of the fuel gases and the oxidant gases, and frame members for reinforcing outer peripheries of the membrane electrode assemblies may be provided in the cells, as needed.

In the fuel cell stacks, such cells are stacked, such that they are electrically connected to one another in series.

The fuel cell stacks further include end plates that hold the cell stacks therebetween.

Furthermore, in order to uniformly apply loads to the cell stack, spring modules or elastic members may be placed between the cell stacks and the end plates.

A fuel gas (including, e.g., hydrogen) and an oxidant gas (including, e.g., oxygen) are supplied to each of cells in the fuel cell stacks having the above-described structure to thereby continuously extract electrical energies.

As examples of conventional fuel cell stacks, structures in which irregular shapes are provided on end plates for the purpose of weight saving thereof (JP-A-2009-277358), structures in which any refrigerant flow channels are not provided on cells present at edges of the cell stacks for the purpose of suppressing heat release from endplates (WO/2010/106753), and structures in which irregular shapes are provided on cell-stack-facing surfaces of end plates (WO/2002/082573) have been known.

### SUMMARY

Meanwhile, as one advantage of polymer electrolyte fuel cell stacks, it has been known that they are operated at relatively low temperatures. However, in fuel cell stacks, power-generation properties deteriorate (typically, output power would be decreased) when temperatures of the cells increase above threshold levels.

Therefore, in order to realize higher power-generation properties in fuel cell stacks, temperature control throughout the cell stacks is critical.

In this point, conventional fuel cell stacks have structures in which any refrigerants used for cooling cell stacks are not supplied edges of the cell stacks. Thus, there would be concerns that temperatures of cells present at the edges of the cell stacks (i.e., edges of the cells in the direction of the stacking directions of cells; the same applies hereafter) elevate to threshold levels.

For example, the above-mentioned problem may be caused in the conventional art disclosed in JP-A-2009-277358 although this conventional art attempts at weight saving of end plates by way of providing irregularities in the end plates.

That is, the conventional art of JP-A-2009-277358 is not meant to help any heat radiation from the edges of the cell stacks, and thus, the temperatures of edges of the cell stacks would be elevated in cases where, for example, flows of refrigerant to the edges of the cell stacks are small, or the refrigerant flow channel to the edges of the cell stacks are reduced.

Moreover, in the conventional arts disclosed in WO/2010/106753, a structure in which any refrigerant flow channels for cooling the edges of the cell stacks are not provided is adopted.

Consequently, in the conventional art of WO/2010/106753, sufficient heat radiation would not be secured at the edges of the cell stacks, and thus, power-generation performance deteriorates under conditions of high current density, although good performance can be achieved under operation conditions of relatively small current density (e.g., 0.5 A/cm² or smaller), even if heat radiation from the edges of the cell stack is somewhat suppressed, since an amount of heat generation is small under such operation conditions.

Furthermore, in the conventional art disclosed in WO/2002/082573, a structure includes surfaces of the current collectors, the end plates, and the elastic members provided with irregular shapes, such that the contact areas are reduced.

However, also in the conventional art of WO/2002/082573, since heat radiation from the edges of the cell stacks is suppressed, amounts of heat generation in the cell stacks are small under such operation conditions, and thus, good performance can be achieved under operation conditions of relatively small current density where any particular heat radiation from the edges is required. However, under conditions of relatively high current density, sufficient heat radiation is not secured. Consequently, temperatures of edges of the cell stacks becomes elevated, and thus, power-generation performance deteriorates.

The present disclosure is conceived in order to solve the above problems. That is, an object of the disclosure is to provide polymer electrolyte fuel cell stacks that make it possible to improve heat-radiation properties of the cell stacks.

Provided are fuel cell stacks, including: a cell stack including separator plates, and cells each placed between the separator plates; a pair of current collectors that holds external lateral surfaces of the cell stack in a cell-stacking direction; and a pair of end plates that holds the pair of current collectors from outsides of said current collectors in the cell-stacking direction, wherein the cell stack possesses (i) at least one first opening formed on one external lateral surface of said cell stack, said one external lateral surface located along a direction perpendicular to the cell-stacking direction, (ii) a second opening formed on an external lateral surface of the cell stack opposite to the one external lateral surface, and (ii) at least one passage that extends through an inside of the cell stack from the at least one first opening or the at least one second opening.

The fuel cell stacks according to the present disclosure exhibit improved heat-radiation properties of cell stacks.

### BRIEF DESCRIPTION OF THE DRAWINGS

FIG. 1 is an external perspective view of a fuel cell stack according to a first embodiment.

FIG. 2 is a lateral view of the fuel cell stack according to the first embodiment.

FIG. 3 is an exploded diagram of components in the fuel cell stack according to the first embodiment.

FIG. 4A is a diagram that shows one example of a fuel gas flow channel in the fuel cell stack according to the first embodiment.

FIG. 4B is a diagram that shows one example an air flow channel in the fuel cell stack according to the first embodiment.

FIG. 5 is an exploded view of a structure of a fuel cell stack according to a variation of the first embodiment.

FIG. 6 is a lateral view of a fuel cell stack according to a second embodiment.

FIG. 7 is an external perspective view of an end plate for the fuel cell stack according to the second embodiment.

FIG. 8 is a lateral view of an endplate for the fuel cell stack according to the second embodiment.

FIG. 9 is a diagram that shows one example of an air flow channel in fuel cell stack according to the third embodiment.

### DESCRIPTION OF EMBODIMENTS

Hereinafter, embodiment of the disclosure will be described with reference to the drawings.

The same rectangular coordinate systems (X, Y, Z) are shown in the drawings in order to clarify positional relations among components.

Hereafter, the embodiments will be described provided that a plus direction of the X axis refers to a stacking direction of cells in a cell stack 200 (hereinafter, simply referred to as “cell-staking direction”), and a plus direction of the Z axis, and a plus direction of the Y axis refer to two direction perpendicular to the cell-stacking direction.

### First Embodiment

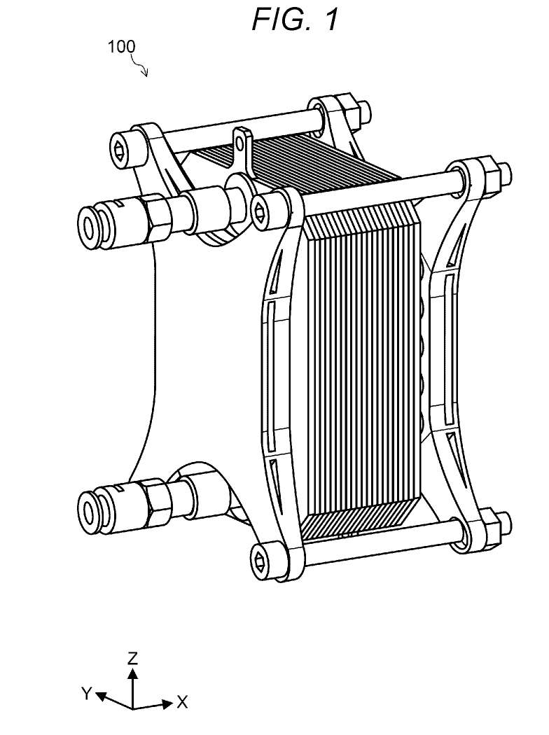

Hereinafter, a structure of the fuel cell stack according to the first embodiment 100 will be described with reference to FIGS. 1 to 5.

FIG. 1 is an external perspective view of a fuel cell stack 100 according to this embodiment.

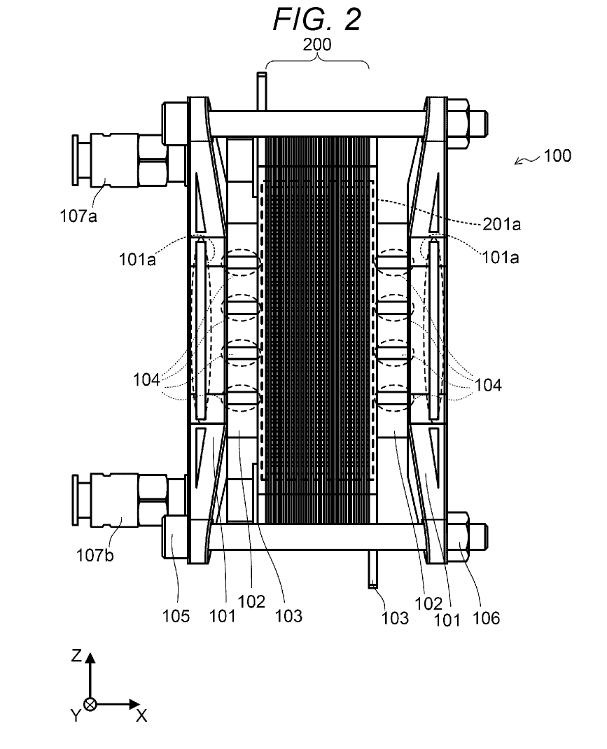

FIG. 2 is a lateral view of the fuel cell stack 100 according to this embodiment.

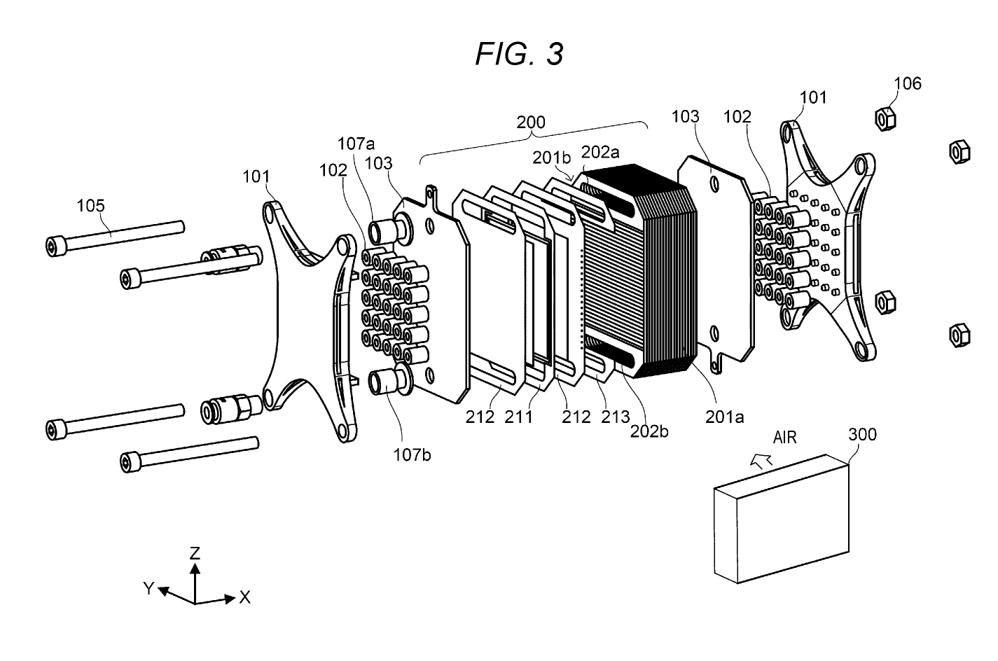

FIG. 3 is an exploded diagram of components in the fuel cell stack 100 according to this embodiment.

The fuel cell stack 100 according to this embodiment includes: a cell stack 200, a pair of current collectors 103, elastic members 102, a pair of end plates 101, and fastening members 105 and 106.

In the fuel cell stack 100 according to this embodiment, the cell stack 200 is located in the middle position, the pair of current collectors 103 hold both sides of the cell stack 200 therebetween along the cell-stacking direction, and the pair of end plates 101 further hold the pair of current collectors 103 therebetween.

Then, the fuel cell stacks 100 has an integrally fastened structure in which the pair of endplates 101 are fastened by fastening members 105 and 106 (e.g., bolts, nuts).

Additionally, the elastic members 102 are provided between the end plates 101 and the current collector 103, and thus, serve as members for applying compression stress caused by the pair of end plates 101 uniformly onto planes of the cell stack 200.

In the fuel cell stack 100 according to this embodiment, the end plate 101, the elastic member 102, and the current collector 103 all provided at the plus X direction side of the cell stack 200, and the end plate 101, the elastic member 102, and the current collector 103 all provided at the minus X direction side of the cell stack 200 are bilaterally symmetric along the cell-stacking direction (therefore, when configurations of the end plates 101, the elastic members 102, and the current collectors 103, descriptions thereon would be provided below with reference to configurations found at one side).

Additionally, the fuel cell stack 100 according to this embodiment may be provided adjacent to an air-supply unit 300 so that forced convection of the air is taken place along the ±Y direction Y.

FIG. 3 shows an embodiment in which, as one example, a blast fan serving the air-supply unit 300 is provided at the minus Y direction side of the cell stack 200.

### <Cell Stack 200>

The cell stack 200 is formed by stacking or adhering multiple cells 211 between separator plate 212 along the cell-stacking direction.

The cells 211 each correspond to the above-mentioned membrane electrode assemblies, and are configured by a planar polyelectrolyte membrane, and fuel and air electrodes that hold the polyelectrolyte membrane therebetween.

The separator plates 212 are tabular members that prevent the fuel gas (e.g., hydrogen-containing gas) supplied to fuel electrodes in the cells 211, and the oxidant gas (the air in this embodiment) supplied to the air electrodes from mixing with each other.

Flow channels for the fuel gas, and flow channels for the air serving as the oxidant gas are separately formed on the separator plates 212.

Sealing members 213 that prevent the fuel gas from leaking to the outside atmosphere are provided at both edges of the cell stack 200 in the cell-stacking direction, and at predetermined positions in the cell-stacking direction.

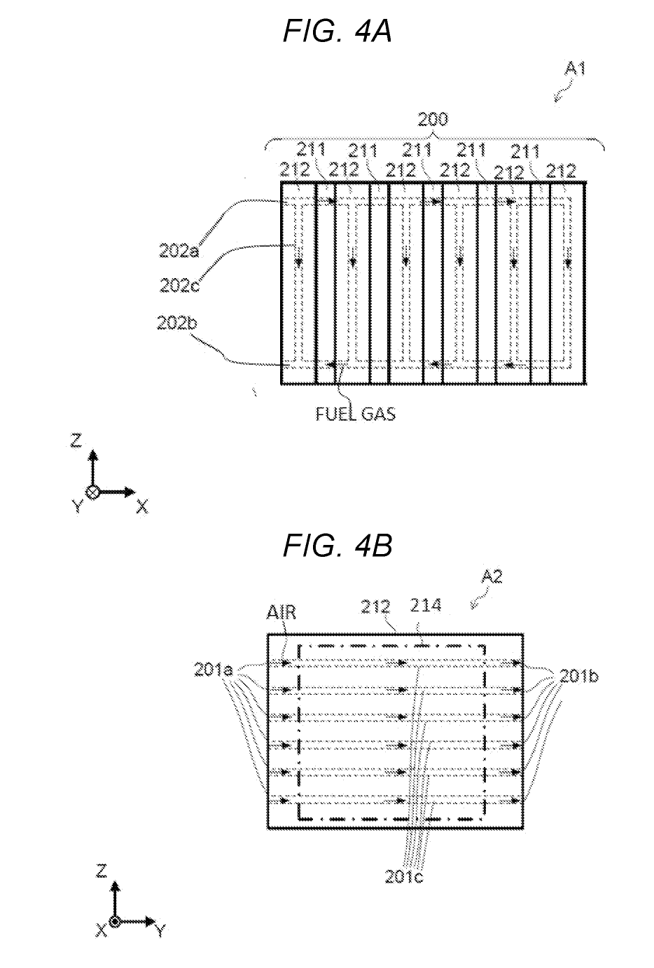

FIGS. 4A and 4B show one example of the fuel gas flow channels and the air flow channels in the fuel cell stack 100 according to the present embodiment.

FIG. 4A shows a cross-section (X-Z cross-section) of the cell stack 200 according to this embodiment along the cell-stacking direction.

FIG. 4A shows the fuel gas flow channels (an area A1 shown by dotted lines; hereinafter referred to as “fuel gas flow channel(s) A1”).

FIG. 4B shows a cross-section (Y-Z cross-section) of the cell stack 200 according to this embodiment in two directions perpendicular to the cell-stacking direction.

FIG. 4B shows the air flow channels (an area A2 shown by dotted lines; hereinafter referred to as “air flow channel(s) A2”).

In addition, a dashed-dotted line found in FIG. 4B refers to the area 214 occupied by the air electrode over the X-Z plane.

The cell stack 200 possesses fuel gas flow channels A1 that pass through separator plates 212 in the cell-stacking direction (FIG. 4A).

Furthermore, the cell stack 200 possesses air flow channels A2 along a direction (±Y direction in this embodiment) perpendicular to the stacking direction of cell 211 (FIG. 4B).

In addition, in the cell stack 200 according to this embodiment, the air flowing through the air flow channels A2 are employed as a refrigerant and an oxidant for the cells 211.

The fuel gas flow channels A1 are formed by, for example, a fuel gas-supply port 202a and a fuel gas-discharge vent 202b provided in the separator plate 212 present at one edge position in the cell-stacking direction, and a fuel gas-communicating passage 202c that pass between the fuel gas-supply port 202a and the fuel gas-discharge vent 202b.

In the fuel gas flow channels A1, the fuel gas is supplied from the fuel gas-supply port 202a, then passes through the fuel gas-communicating passages 202c, and is eventually discharged from the fuel gas-discharge vent 202b.

Moreover, a pipe member 107a that supplies the fuel gas to the fuel gas-supply port 202a from the outside is connected to the fuel gas-supply port 202a.

Furthermore, a pipe member 107b that discharges the fuel gas to the outside from the fuel gas-discharge vent 202b is connected to the fuel gas-discharge vent 202b.

Flow channels that supply the fuel gas to the cells 211, and flow channels that discharge the fuel gas from the cell 211 (not shown in the figures) are also connected to the fuel gas flow channels A1.

According to the above-described structure, the fuel gas is supplied to the fuel electrodes in the cells 211.

The air flow channels A2 are formed by, for example, air-supply ports 201a and air-discharge vents 201b on one external lateral surface and the opposite external lateral surface of the cell stack 200 in the direction perpendicular to the cell-stacking direction (the lateral surfaces at the plus and minus Y direction sides, respectively, in this embodiment), and air-communicating passages 201c that extend through the cell stack 200 from the first or second air-supply ports 201a and air-discharge ports 201b.

The air-communicating passages 201c may more preferably be communication passages that pass between the air-supply ports 201a and the air-discharge vents 201b, as shown in FIG. 4B.

The air-communicating passages 201c may be provided in straight lines between the air-supply ports 201a and the air-discharge vents 201b.

In addition, the air-communicating passages 201c need to at least extend to the vicinity of the cell 211.

The air-supply ports 201a and the air-discharge vents 201b are provided so as to be opened to the space outside the fuel cell stack 100.

In this embodiment, at least one air-supply port 201a is provided on the external lateral surface of the cell stack 200 at the minus Y direction side.

In the same manner, at least one air-discharge vent 201b is provided on the external lateral surface of the cell stack 200 at the plus Y direction side.

The air-supply ports 201a, the air-discharge vents 201b, and the air-communicating passages 201c may be formed, for example, as grooves on the separator plate 212.

The air is introduced from the air-supply ports 201a provided on the lateral surface at the minus Y direction by operation of the air-supply unit 300 such as a blast fan provided at the minus Y direction side of the cell stack 200, passes through the air flow channels A2, and then, is discharged from the air-discharge vents 201b provided on the plus Y direction side.

The air flow channels A2 are formed on multiple areas of the separator plate 212 along the Z direction in parallel.

Accordingly, the air is caused to reach the whole cell 211, and thus, the cell 211 is effectively cooled, while the temperature of the cell 211 become even.

Moreover, the air flow channels A2 are typically provided on the respective separator plates 212 (for the sake of convenience, only one separator plate 212 is shown in FIG. 4B).

Furthermore, flow channels (not shown in the figures) for supplying the air to air electrodes in the cells 211, and flow channels (not shown in the figures) for discharging the air from the air electrodes in the cells 211 are connected to the air flow channels A2 in a manner that these flow channels are branched from the air flow channels A2.

In other words, the air-communicating passages 201c extend to the air electrodes in the cells 211.

According to the above-described structure, the air is supplied to the air electrodes in the cells 211.

In addition, the air flow channels A2 and the fuel gas flow channels A1 are provided in a manner that they do not communicate with each other in the cell stack 200.

In this manner, the air is supplied to the cells 211 through the air flow channels A2, while the fuel gas is supplied to the cells 211 through the fuel gas flow channels A1. Then, based on these gases, power generation (i.e., electrochemical reactions) is carried out inside the electrode catalyst layers.

However, the structure of the cell stack 200 and the like can be modified in various ways.

For example, although the air-supply ports 201a, and the air-discharge vents 201b, and the air-communicating passages 201c are formed on the separator plate 212 in the above-described configuration, alternatively or together with such a configuration, air-supply ports, and air-discharge vents may be provided on the cells 211 (membrane electrode assemblies) or sealing members 213.

Moreover, although the air flow channels A2 serve as air flow channels for introducing a refrigerant into the cell stack 200, and also, as air flow channels for introducing an oxidant into the cell stack 200 in the above-described configuration, for example, air flow channels for the refrigerant, and air flow channels for the oxidant may separately be provided.

Moreover, although the air-supply ports 201a and the air-discharge vents 201b are provided on the two opposite surfaces among the external lateral surfaces in a direction perpendicular to the cell stacking direction in the above-described configuration, for example, the air-supply ports 201a and the air-discharge vents 201b may be provided on three or more surfaces.

Furthermore, in cases where the cells are not rectangular, the surfaces in which the air-supply ports 201a and the air-discharge vents 201b may be curved.

Furthermore, shapes of the air-supply ports 201a, and shapes of air-discharge vent 201b may be the same or may be different per cell 211.

The shapes of the air-supply ports 201a and shapes of air-discharge vent 201b provided on the end cells may be made larger according to distributions of flows of the air supplied by the air-supply unit 300 such as a blast fan (not shown in the figures).

Furthermore, although the fuel gas-supply ports 202a and the fuel gas-discharge vents 202b serving as fuel-gas-supply/discharge structures are provided within the cell stack 200 in the above-described configuration, the fuel-gas-supply/discharge structures may be formed by so-called external manifolds or the like.

Furthermore, although the fuel gas-supply ports 202a and the fuel gas-discharge vents 202b are connected to the pipe members 107a and 107b, respectively, via current collectors 103 in the above-described configuration, the fuel gas-supply ports 202a and the fuel gas-discharge vents 202b may be connected directly to the pipe members 107a and 107b, respectively, with adhesives or gaskets, without current collectors 103.

### <End Plate 101>

The pair of end plates 101 hold the cell stack 200 the pair of current collectors 103 in the cell-staking direction, and form both edges of the fuel cell stack 100 in the cell-stacking direction.

The end plates 101 are typically tabular.

Thus, the end plates 101 are provided such that their tabular surfaces face tabular surfaces of the current collector 103.

Furthermore, the end plates 101 possess hollow parts 101a that pass through the end plate 101 from one lateral surface (plus Y direction side) to the opposite lateral surface (minus Y direction side) along a direction from the air-supply ports 201a toward the air-discharge vents 201b.

In other words, the hollow parts 101a form air flow channels in parallel with the air flow channels A2 in the cell stack 200.

Accordingly, the air from the air-supply unit 300 flows into the hollow parts 101a, and thus, heat-radiation flow channels can be formed.

As a result, the edges of the cell stack 200 can more effectively be cooled.

### <Elastic Member 102>

The elastic members 102 are provided between the end plates 101 and the current collectors 103, and thus, serve as members for applying loads evenly to the cell stack 200 along the cell-stacking direction.

For example, rubber materials (e.g. elastomers) may be employed for the elastic members 102.

The fuel cell stack 100 according to this embodiment has multiple elastic members 102 separated from one another, between the end plates 101 and the current collectors 103.

The elastic members 102 may each have tubular shapes in an axial direction of the ±X direction.

One edge of each of the elastic members 102 may be brought into contact with the adjacent end plate 101, the other edge may be brought into contact with the adjacent current collector 103. Accordingly, the elastic member 102 is retained between the end plate 101 and the current collector 103 while the elastic member 102 is pressed therebetween.

The elastic member 102 is provided so that pass-through slots 104 are formed in an area, across which the end plate 101 and the current collector 103 face each other, along the ±Y direction.

For example, with regards to locations where multiple elastic members 102 are provided, the multiple elastic members 102 are not provided in certain linear areas along the ±Y direction (i.e., areas where pass-through slots 104 are formed) in an area in which the end plate 101 and the current collector 103 face each other. Accordingly, the pass-through slots 104 are formed.

Typically, multiple elastic members 102 may be arrayed in a grid pattern within a X-Z plane.

Accordingly, the air from the air-supply unit 300 is caused to flow into the pass-through slots 104, and thus, heat-radiation flow channels can be formed.

As a result, edge parts of the cell stack 200 can more effectively be cooled.

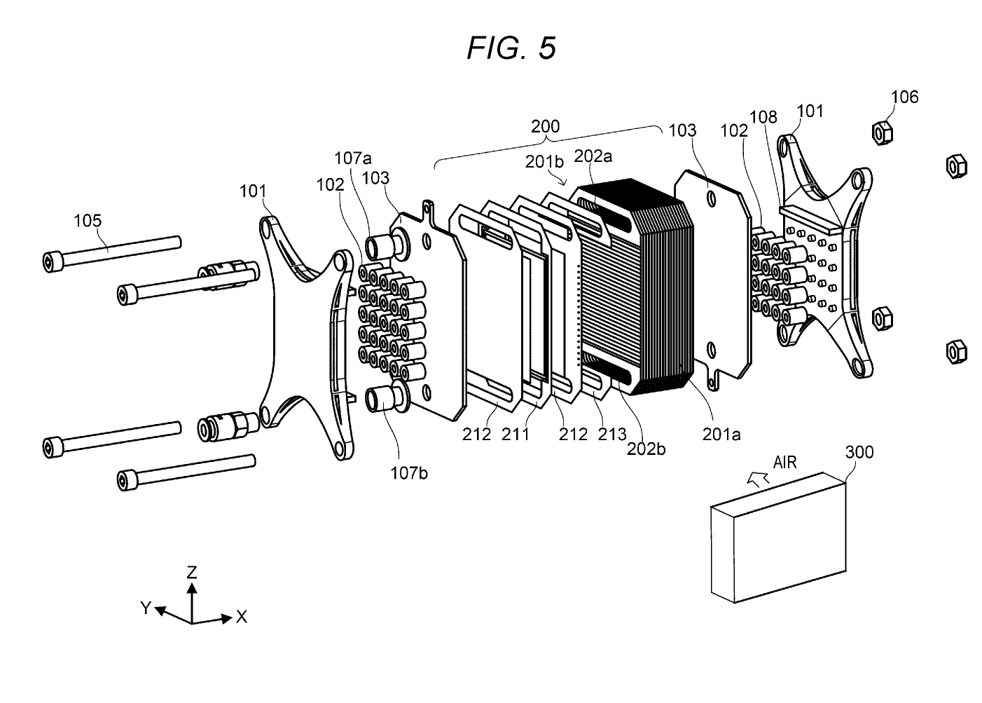

FIG. 5 is an exploded view that shows a configuration of one variation of the fuel cell stack 100 according to this embodiment.

In the fuel cell stack 100 according to this variation, the end plate 101 is provided with a rib 108 that extends in the extending direction from the air-supply ports 201a toward the air-discharge vents 201b, and heat-radiation flow channels are formed between the rib 108 and wall parts of the elastic members 102.

The rib 108 prevents blasts from the air-supply unit 300 from being released to the outside, and thus, causes the blast to reach the elastic members 102.

However, shapes, materials, the number, etc. of the elastic members 102 are not particularly limited in the disclosure.

For example, one elastic member 102 may be formed as a single unit in an area, across which the end plate 101 and the current collector 103 face each other.

Furthermore, for examples, the pass-through slots 104 may be provided in either the plus X direction side area or the minus X direction side area.

In that case, the pass-through slots 104 are preferably formed in the side where a flow of the reaction gas flowing into the cell is larger, and thus, a required amount of heat radiation is also larger in the area in which the end plate 101 and the current collector 103 face each other.

Furthermore, the elastic members 102 may be formed based on spring materials.

Furthermore, the elastic members 102 may be provided only in either an area between the end plate 101 and the current collector 103 at the plus X direction side of the cell stack 200, or an area between the end plate 101 and the current collector 103 at the minus X direction side of the cell stack 200.

Furthermore, the elastic members 102 may be connected to the endplate 101 and the current collector 103 via an insulation member.

### <Current Collector 103>

The pair of current collectors 103 hold external lateral surfaces of the cell stack 200 therebetween, and collect electric currents produced from the cell stack 200.

For the current collectors 103, for example, tabular electrically conductive materials may be employed.

### <Fastening Members 105 and 106>

The fastening members 105 and 106 fasten the end plates 101, respectively, in a state where the cell stack 200, and the current collectors 103 are placed between the endplates 101 along the cell-stacking direction.

In the present embodiment, the fastening members 105 may be bolts, and the fastening members 106 may be nuts. Both of the end plates 101 may be fastened at four corners of the endplates 101 based on such fastening members 105 and 106.

However, the configurations of the fastening members 105 and 106 are not particularly limited in the present disclosure.

For the fastening members 105 and 106, for example, clip-shaped or band-shaped members may be employed.

The fastening members 105 and 106 are preferably provided at positions where these members block the first and second air-supply ports 201a and 201b in the cell stack 200, the pass-through slots 104 in the elastic members 102, and the hollow parts 101a in the end plates 101.

### [Advantages]

As described above, according to the fuel cell stack 100 according to the this embodiment, the cell stack 200 possesses the air-supply ports 201a and 201b that are provided on one lateral surface and the opposite lateral surface among the external lateral surfaces in the direction perpendicular to the cell-stacking direction (e.g., the lateral surface at the plus Y direction side, and the lateral surface at the minus Y direction side), and the air-communicating passages 201c that extend through an area from the air-supply ports 201a/201b to the cell 211. Thus, the outside air is introduced to the cells 211 as a refrigerant through the air-supply ports 201a/201b and the air-communicating passages 201c.

Therefore, according to the fuel cell stack 100 of this embodiment, the outside air can be introduced directly to edges of the cells 211 in the cell stack 200.

Accordingly, heat radiations from edges and the like of the cell stack 200 can be promoted, and therefore, deteriorations in power-generation performance due to overheat of the edges of the cell stack 200 can be suppressed even under conditions where amounts of power generation are increased (e.g., at higher current densities).

Furthermore, the fuel cell stack 100 according to this embodiment possesses the air-communicating passages 201c that pass between the air-supply ports 201a (first air-supply ports 201a) and the air-discharge vents 201b (second air-discharge vents 201b), within the cell stack 200.

Accordingly, the outside air can be introduced directly to all of the cells 211.

Furthermore, according to the above configuration, supply of the air to the air electrodes in the cells 211 in the cell stack 200 can be carried out more smoothly.

Furthermore, in the fuel cell stack 100 according to this embodiment, pass-through slots 104 that extend along a direction (±Y direction) from the air-supply ports 201a (first air-supply ports 201a) to the air-discharge vents 201b (second air-discharge vents 201b) in areas where the elastic members 102 are not provided, between the end plates 101 and the current collectors 103.

Accordingly, heat radiation from the edges of the cell stack 200 can further be improved.

Furthermore, according to the fuel cell stack 100 according to this embodiment, the end plates 101 possess hollow parts 101a that pass through the end plates 101, and extend in a direction (±Y direction) from the air-supply ports 201a (first air-supply port 201a) toward the air-discharge vents 201b (second air-discharge vents 201b).

Accordingly, heat radiation properties of edges of the cell stacks 200 can further be improved.

In addition, the fuel cell stack 100 according to this embodiment makes it possible to realize weight saving, and to suppress deteriorations in power-generation properties, and therefore, the fuel cell stack 100 according to this embodiment would be suitable as small and light fuel cells, in particular, fuel cells for mobile objects such as drones.

### Second Embodiment

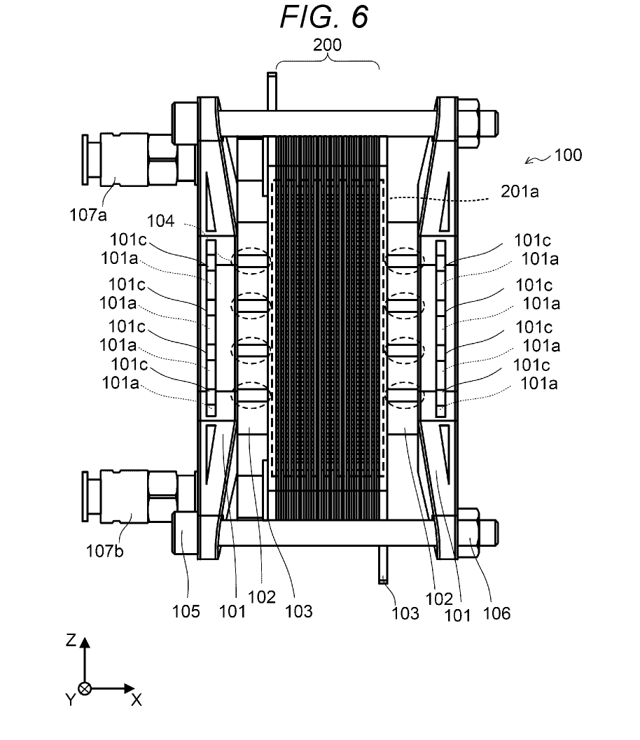

Next, the fuel cell stack according to the second embodiment 100 will be described with reference to FIGS. 6 to 8.

The fuel cell stack 100 according to this embodiment differs from the first embodiment with regards to shapes of end plates 101.

In addition, for the same structures as those described for the first embodiment will be omitted for the sake of simplification. The same shall apply to other embodiments described below.

FIG. 6 is a lateral view of the fuel cell stack 100 according to this embodiment.

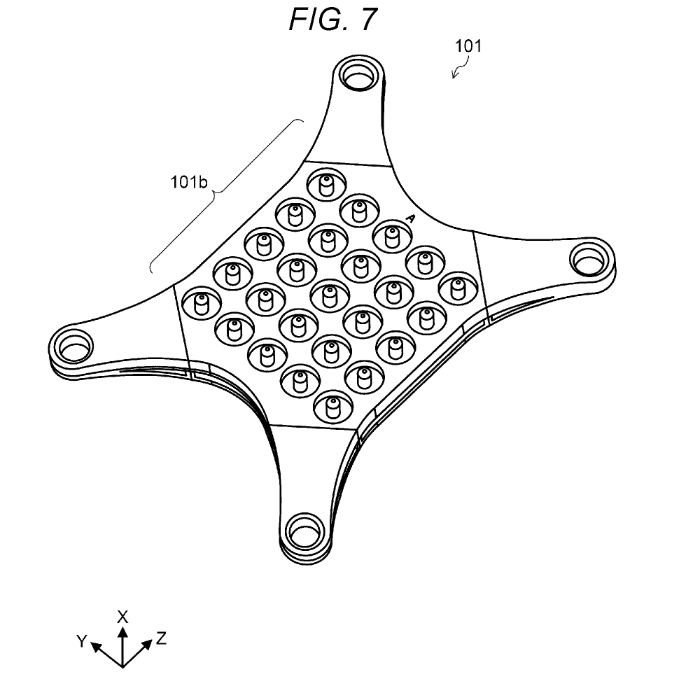

FIG. 7 is an external perspective view of an end plate 101 for the fuel cell stack 100 according to the second embodiment.

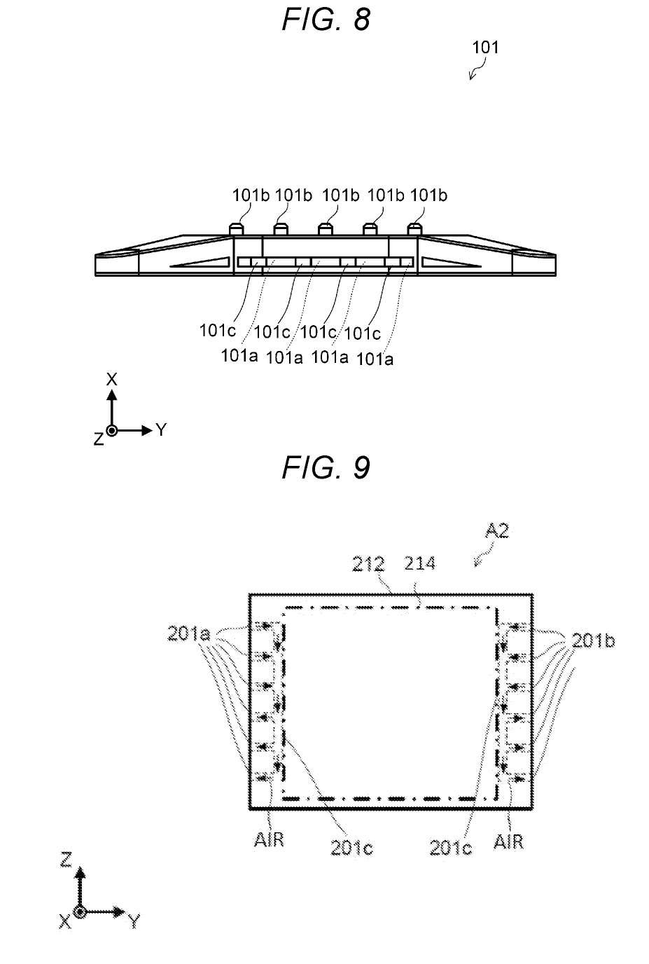

FIG. 8 is a lateral view of the end plate 101 for the fuel cell stack 100 according to the second embodiment.

The endplates 101 in this embodiment each possess locking parts 101b for holding elastic members 102, at their surfaces facing current collectors 103 (i.e., a minus X direction side surface of the end plate 101 placed at the pus X direction side, and a plus X direction side surface of an endplate 101 placed at the minus X direction side).

The locking parts 101b are formed on the surfaces that face the current collectors 103, and have concave or convex shapes that engage with the elastic members 102.

The locking parts 101b are provided on the surfaces facing the current collectors 103 so as to accord with positions where the elastic members 102 are located, such that the locking parts 101b will engage with the elastic members 102.

The elastic members 102 are engaged with the respective concave and convex shapes of the locking parts 101b.

Accordingly, the elastic members 102 are each fixed and positioned at certain locations.

In addition, although the locking parts 101b may have concave or convex shapes as mentioned above, the locking parts 101b may each have combinations of concave and convex shapes as shown in FIG. 7. However, the locking parts 101b preferably have convex shapes while the elastic members 102 have spring-like shapes.

According to the above-described configuration, while large heat-radiation flow channels can be secured, sufficient thickness of end plates 101 brought into contact with the elastic members 102 can be secured, and thus, deformation of the end plates 101 due to the fastening loads can be suppressed.

Furthermore, multiple strut parts 101c are provided inside hollow parts 101a in the end plates 101.

The strut parts 101c each extend so as to connect one inner surface and the other inner surface of the hollow parts 101a in the cell-stacking direction.

According to the above-described configuration, compression stress caused in the end plates 101 when the elastic members 102 are compressed for the purpose of fastening can be received by the strut parts 101c, and thus, deformation of endplates 101 can be suppressed even in cases where the end plates 101 have hollow parts 101a as described above.

Additionally, since the strut parts 101c are arrayed in the same manner as the elastic members 102, flows of the air inside the hollow parts 101a will not be impeded by the strut parts 101c, and thus, sufficient heat radiation can be obtained.

### Third Embodiment

Next, the fuel cell stack according to the third embodiment 100 will be described with reference to FIG. 9.

The fuel cell stack 100 according to this embodiment differs from the first embodiment with regards to structures of air flow channels A2 in the cell stack 200.

Matters not mentioned in this embodiment may be the same as those described for the above-described embodiment.

FIG. 9 is a view that shows one example of air flow channels A2 in the fuel cell stack 100 according to this embodiment.

FIG. 9 corresponds to FIG. 4B for the first embodiment.

The air-communicating passages 201c according to this embodiment do not connect the air-supply ports 201a and the air-discharge vents 201b. The air-communicating passages 201c extend to an internal area of the cell stack 200 from the air-supply ports 201a and the air-discharge vents 201b, respectively, and are provided along the outer circumference of the area 214 occupied by the air electrode (along the ±Z direction).

In addition, each air-communicating passage 201c in this embodiment is formed in such a manner that the air-communicating passage 201c connects the multiple air-supply ports 201a (or multiple air-discharge vents 201b) formed on an external lateral surface of a separator plate 212.

According to the above configuration, the air introduced into the air-communicating passages 201c is circulated.

As a result, in the air flow channels A2 according to this embodiment, the outside air is introduced into the air-communicating passages 201c from the air-supply ports 201a, which are formed on one external lateral surface of the cell stack 200, while the introduced outside air is discharged from the air-supply ports 201a formed on the same external lateral surface.

In the same manner, the outside air is introduced into the air-communicating passages 201c from the air-discharge ports 201b, which are formed on the opposite external lateral surface of the cell stack 200, while the introduced outside air is discharged from the air-discharge ports 201b formed on the same external lateral surface.

In other words, the air flow channels A2 according to this embodiment introduce the outside air from the air-supply ports 201a to pass through the internal area of the cell stack 200, serving as a refrigerant for cooling a plus Y direction side edge of the cell 211.

Furthermore, the air flow channels A2 according to this embodiment introduce the outside air from the air-discharge ports 201b to pass through the internal area of the cell stack 200, serving as a refrigerant for cooling a minus Y direction side edge of the cell 211.

In this way, the air serving as a refrigerant is introduced into edge portions of the cell stack 200, and thus, overheat of the edges of the cell stack 200 will be suppressed.

As described above, also, in the fuel cell stack 100 according to this embodiment, the outside air can be introduced directly into edges of cells 211 in the cell stack 200.

Accordingly, since heat radiation from edges and the like of the cell stack 200 can be promoted, deteriorations in the power-generation performance due to overheat of edges of the cell stack 200 can be suppressed.

In addition, in the fuel cell stack 100 according to this embodiment, introduction of the outside air into air electrodes in the cells 211 may be carried out through the air-communicating passages 201c. Alternatively, the introduction of the air may be carried out through another air flow channel other than the air-communicating passages 201c.

### Other Embodiments

In the above-described embodiments, merely examples of configurations of fuel cell stacks 100 have been shown. Needless to say, features/elements described for the above embodiments can be combined in various ways.

Furthermore, although the above-described embodiments, which are merely examples of configurations of fuel cell stacks 100, include air-supply units 300, embodiments in which any air-supply units 300 are not provided are possible especially in cases where the air can be sufficiently introduced into the cell stacks 200 even based only on natural convection.

Although specific examples of the disclosure have been described above in detail, they are merely examples, and therefore, restrict the claims.

The scope of claims can include those obtained by varying or modifying the above-described examples.

The fuel cell stacks according to the present disclosure make it possible to improve heat-radiation properties of the cell stack, and therefore, thin fuel cell modules can be realized.

Therefore, the disclosure is useful as fuel cells used as portable power supplies, power supplies for electric cars, household cogeneration systems, and the like.

What is claimed is:

1. A fuel cell stack, comprising:
a cell stack including separator plates, and cells placed between the separator plates;
a pair of current collectors that hold external lateral surfaces of the cell stack in a cell-stacking direction; and
a pair of end plates that hold the pair of current collectors from outsides of said current collectors in the cell-stacking direction, wherein
the cell stack possesses (i) at least one first opening formed on one external lateral surface of said cell stack, said one external lateral surface located along a direction perpendicular to the cell-stacking direction, (ii) a second opening formed on an external lateral surface of the cell stack opposite to the one external lateral surface, and (ii) at least one passage that extends through an inside of the cell stack from the at least one first opening or the at least one second opening.

2. The fuel cell stack according to claim 1, wherein the at least one passage comprises a passage that connects the at least one first opening and the at least one second opening inside the cell stack.

3. The fuel cell stack according to claim 1, wherein the at least one passage extends from the at least one first opening and the at least one second opening, and is provided in an area along an outer circumstance of an area occupied by air electrodes.

4. The fuel cell stack according to claim 1, wherein the at least one passage extends to air electrodes in the cell.

5. The fuel cell stack according to claim 1, further comprising an air-supply unit that causes forced convection of air in a direction from the at least one first opening toward the at least one second opening.

6. The fuel cell stack according to claim 1, further comprising elastic members placed between the end plates and the current collectors, respectively.

7. The fuel cell stack according to claim 6, wherein at least one passage extending between the end plates and the current collectors along a direction from the at least one first opening toward the at least one second opening is provided in an area where the elastic members are not present.

8. The fuel cell stack according to claim 6, wherein the end plates each have concave or convex shaped locking parts engaging with the elastic members, in lateral surface of said end plates each facing the current collectors.

9. The fuel cell stack according to claim 1, wherein each of the end plates has a hollow part that extends from one lateral side of said end plate to another lateral surface of said end plate along a direction from the at least one first opening toward the at least one second opening.

10. The fuel cell stack according to claim 9, wherein each of the end plates has within the hollow part multiple strut parts that connect one inner surface and another inner surface facing said one inner surface in the cell-stacking direction to each other.
